(19) United States
(12) Patent Application Publication
(10) Pub. No.: US 2026/0236337 A1
(43) Pub. Date: Aug. 13, 2026

(54) SYSTEMS AND METHODS FOR IDENTIFYING NETWORK COMPONENT FAILURES BY AUTOMATICALLY IDENTIFYING AND FILTERING ANOMALOUS LOG ENTRIES

(71) Applicant: BANK OF AMERICA CORPORATION, Charlotte, NC (US)

(72) Inventors: John Andres Lozes, Wilmington, DE (US); Manonmani Palanichamy, Fort Mill, SC (US); Andrea M. Weisberger, Jacksonville, FL (US); Aravind Singtalur, McKinney, TX (US); Amer Ali, Jersey City, NJ (US); Mohammad Saleem Gaziani, Plano, TX (US); Aisha Jenkins, Atlanta, GA (US); Tonya Kyra Miller, Charlotte, NC (US); Asha Thekkumpurath, Frisco, TX (US); Aaron Gee, Palm Coast, FL (US); Chia-Ho Yu, Ashland, VA (US)

(73) Assignee: BANK OF AMERICA CORPORATION, Charlotte, NC (US)

(21) Appl. No.: 19/050,817

(22) Filed: Feb. 11, 2025

(51) Int. Cl. G06F 11/07

(52) U.S. Cl. CPC G06F 11/079; G06F 11/0709; G06F 11/0781

(57) ABSTRACT

Systems, computer program products, and methods are described herein for identifying network component failures by automatically identifying and filtering anomalous log entries. The present invention is configured to identify a new log entry associated with a system component, wherein the new log entry comprises a plurality of characters and punctuation marks; determine a new punctuation string from the new log entry, wherein the new punctuation string comprises the punctuation marks; identify a historical punctuation string associated with the system component; compare the new punctuation string to the historical punctuation string associated with the system component; determine, based on the comparison, a difference value between the new punctuation string and the historical punctuation string; compare the difference value to a difference threshold; and determine, based on the comparison of the difference value to the difference threshold, a presence of an anomaly in the system component

### FIELD OF THE INVENTION

The present invention embraces a system for identifying network component failures by automatically identifying and filtering anomalous log entries.

### BACKGROUND

In today's electronic environment where many system components and computing devices are used across large area networks, it is more difficult than ever to identify interruption events and potential anomalies for these devices both before they occur and in real or near real time as they occur. Such issues are further exacerbated when patterns arise and log entries indicating these events are difficult to sift through due to their large volume and difficult readability. Thus, a need a exists for a system, computer program product, or computer implemented method that can accurately, efficiently, and dynamically identify these network component failures by automatically identifying and filtering anomalous log entries.

Applicant has identified a number of deficiencies and problems associated with identifying network component failures by automatically identifying and filtering anomalous log entries. Through applied effort, ingenuity, and innovation, many of these identified problems have been solved by developing solutions that are included in embodiments of the present disclosure, many examples of which are described in detail herein.

### SUMMARY

The following presents a simplified summary of one or more embodiments of the present invention, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

In one aspect, a system for identifying network component failures by automatically identifying and filtering anomalous log entries. The system may comprise: a memory device with computer-readable program code stored thereon; at least one processing device operatively coupled to the memory device and at least one communication device, wherein executing the computer-readable code is configured to cause the at least one processing device to: identify at least one new log entry associated with a system component, wherein the at least one new log entry comprises a plurality of characters and punctuation marks; determine at least one new punctuation string from the at least one new log entry, wherein the at least one new punctuation string comprises the punctuation marks; identify at least one historical punctuation string associated with the system component; compare the at least one new punctuation string to the at least one historical punctuation string associated with the system component; determine, based on the comparison of the at least one new punctuation string to the at least one historical punctuation string, a difference value between the at least one new punctuation string and the at least one historical punctuation string; compare the difference value to a difference threshold; and determine, based on the comparison of the difference value to the difference threshold, a presence of an anomaly in the system component.

In some embodiments, the difference value indicates a percentage or weight of difference between the at least one new punctuation string and the at least one historical punctuation string.

In some embodiments, the difference threshold is at least one of a pre-determined threshold value by at least one of a user associated with the system component or by an artificial intelligence (AI) engine.

In some embodiments, the anomaly in the system component is present in an instance where the difference value meets or exceeds difference threshold.

In some embodiments, the anomaly in the system component is not present in an instance where the difference value does not meet or exceed than the difference threshold.

In some embodiments, executing the computer-readable code is further configured to cause the at least one processing device to: identify a plurality of new log entries associated with a pre-determined period; identify, from the plurality of new log entries, the at least one new log entry; determine, from the plurality of new log entries, at least one other new log entry comprising the at least one new punctuation string; and determine, based on the collection of at least one other new log entry and the at least one new log entry, a number of new log entries comprising the new punctuation string.

In some embodiments, executing the computer-readable code is further configured to cause the at least one processing device to: apply the number of new log entries comprising the new punctuation string to a tunable filter; determine, by the tunable filter, a ranking of the number of new log entries comprising the new punctuation string; filter, by the tunable filter, a plurality of new log entries comprising the new punctuation string or other new punctuation strings based on the ranking, wherein the ranking comprises an indicator of anomalous significance; and determine, based on the filtering, a subset of new log entries from the plurality of new log entries comprising one or more punctuation strings.

In some embodiments, executing the computer-readable code is further configured to cause the at least one processing device to: apply the subset of new log entries to an artificial intelligence (AI) engine; and determine, by the AI engine, at least one inference between the subset of new log entries, wherein the AI engine analyzes data of the subset of new log entries, and wherein the data of the subset comprises a plurality of characters and punctuation marks.

In some embodiments, executing the computer-readable code is further configured to cause the at least one processing device to: generate, based on the at least one inference, a report interface component comprising the at least one inference; and transmit the report interface component to a user device and configure a graphical user interface with the report interface component.

In some embodiments, the at least one historical punctuation string is based on the system component at a same historical pre-determined period. In some embodiments, the at least one historical punctuation string is based on the system component at a similar historical pre-determined period.

In some embodiments, the at least one new punctuation string comprises the punctuation marks in a same sequence as the at least one new log entry without the plurality of characters.

In some embodiments, the at least one historical punctuation string comprises punctuation marks in a same sequence as an at least one historical log entry without an associated plurality of historical characters.

Similarly, and as a person of skill in the art will understand, each of the features, functions, and advantages provided herein with respect to the system disclosed hereinabove may additionally be provided with respect to a computer-implemented method and computer program product. Such embodiments are provided for exemplary purposes below and are not intended to be limited.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIGS. 1A-1C illustrates technical components of an exemplary distributed computing environment for identifying network component failures by automatically identifying and filtering anomalous log entries, in accordance with an embodiment of the disclosure;

FIG. 2 illustrates an exemplary artificial intelligence (AI) engine subsystem architecture, in accordance with an embodiment of the disclosure;

FIG. 3 illustrates a process flow for identifying network component failures by automatically identifying and filtering anomalous log entries, in accordance with an embodiment of the disclosure;

FIG. 4 illustrates a process flow for determining a subset of new log entries based on combining the new log entries with the same punctuation strings and filtering the highest ranked new log entries, in accordance with an embodiment of the disclosure;

FIG. 5 illustrates a process flow for transmitting a report interface component comprising inference information to a user device for GUI configuration, in accordance with an embodiment of the disclosure; and

FIG. 6 illustrates a flow diagram for identifying network component failures by automatically identifying and filtering anomalous log entries, in accordance with an embodiment of the disclosure.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

In today's electronic environment where many system components and computing devices are used across large area networks, it is more difficult than ever to identify interruption events and potential anomalies for these devices both before they occur and in real or near real time as they occur. Such issues are further exacerbated when patterns arise and log entries indicating these events are difficult to sift through due to their large volume and difficult readability. Thus, a need a exists for a system, computer program product, or computer implemented method that can accurately, efficiently, and dynamically identify these network component failures by automatically identifying and filtering anomalous log entries.

Accordingly, the present disclosure provides the identification of at least one new log entry associated with a system component, wherein the at least one new log entry comprises a plurality of characters and punctuation marks; the determination of at least one new punctuation string from the at least one new log entry, wherein the at least one new punctuation string comprises the punctuation marks; the identification of at least one historical punctuation string associated with the system component; and the comparison of the at least one new punctuation string to the at least one historical punctuation string associated with the system component. Additionally, the disclosure provides for the determination, based on the comparison of the at least one new punctuation string to the at least one historical punctuation string, of a difference value between the at least one new punctuation string and the at least one historical punctuation string; the comparison of the difference value to a difference threshold; and the determination, based on the comparison of the difference value to the difference threshold, of a presence of an anomaly in the system component

Additionally, and in some embodiments, the disclosure provides for the identification of a plurality of new log entries associated with a pre-determined period; the identification, from the plurality of new log entries, of the at least one new log entry; the determination, from the plurality of new log entries, of at least one other new log entry comprising the at least one new punctuation string; and the determination, based on the collection of at least one other new log entry and the at least one new log entry, of a number of new log entries comprising the new punctuation string. Further, the disclosure may provide for the application of the number of new log entries comprising the new punctuation string to a tunable filter; the determination, by the tunable filter, of a ranking of the number of new log entries comprising the new punctuation string; the filtering, by the tunable filter, of a plurality of new log entries comprising the new punctuation string or other new punctuation strings based on the ranking, wherein the ranking comprises an indicator of anomalous significance; and the determination, based on the filtering, of a subset of new log entries from the plurality of new log entries comprising one or more punctuation strings.

In other words, the disclosure provides a system that identifies errors in logs that could be attributed to larger, system-wide component failures, outages, interruptions, and/or the like. The system identifies these errors by comparing punctuation strings of these log entries and volume changes, and comparing these punctuation strings to historical punctuation strings and volumes for the same components at historical times. Further, the system may use a weighting method to rank the significance of these punctuation string changes to apply a tunable filter, which may filter more extreme and/or more important component failure log entries for further analysis and fixing. Additionally, and in some embodiments, an AI engine may be used to further analyze the filtered log entries to determine other relevant patterns, relationships, and/or the like, for these components and their potential failures. Thus, and importantly, the system may use a tunable filter, which may allow for the log filtering based on new log pattern recognition as a critical aspect, and further, by using the punctuation of the logs allows for quick and accurate log entry categorization for simplified and streamlined comparisons.

Therefore, the present disclosure improves over existing solutions as existing solutions may only include the full and voluminous aspect of assessing entire log entries, including those entries that may not comprise any anomalies. Thus, the log entries that may be abnormal could be drowned out by the normal/regular log entries. In contrast, the disclosure provided herein allows for the filtering of new log entry patterns (e.g., new log message types or significant volume changes) which further enables efficient identification and analysis. Further, and by using punctuation as one of the deciding factors for anomalies, the system may ignore variable elements (e.g., characters which may indicate timestamps, log levels IP addresses, thread numbers, and/or the like) that may not be needed for initial flagging of the events.

What is more, the present invention provides a technical solution to a technical problem. As described herein, the technical problem includes identifying network component failures efficiently, automatically, and dynamically. The technical solution presented herein allows for the identification of these network component interruptions or abnormalities both before they occur and/or in real time or near real time as they occur. In particular, the system described herein is an improvement over existing solutions to the identification of these interruptions and abnormal events in computing networks, (i) with fewer steps to achieve the solution, thus reducing the amount of computing resources, such as processing resources, storage resources, network resources, and/or the like, that are being used, (ii) providing a more accurate solution to problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

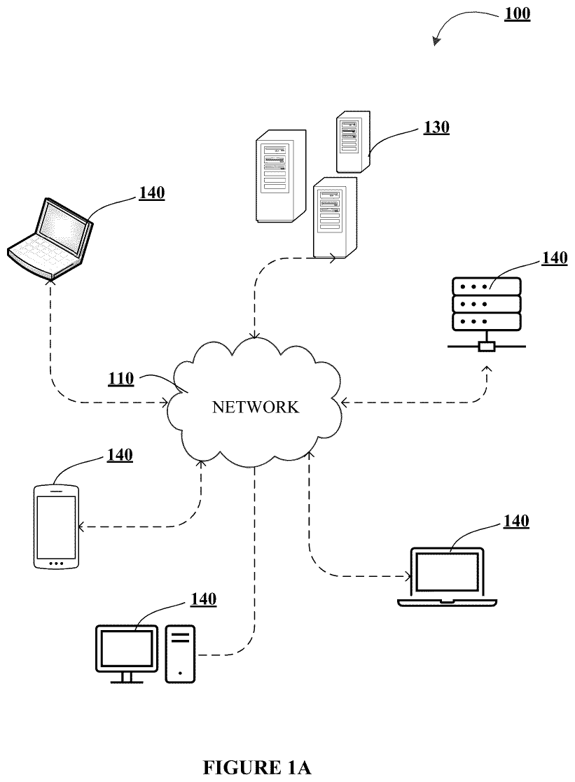

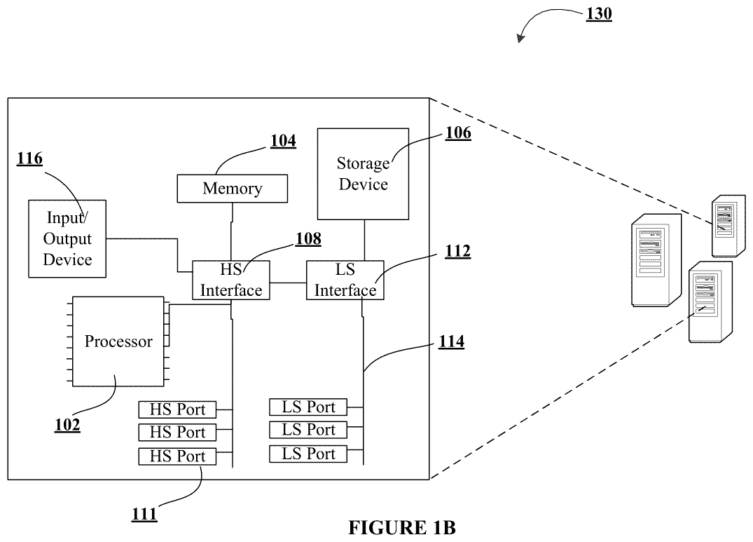

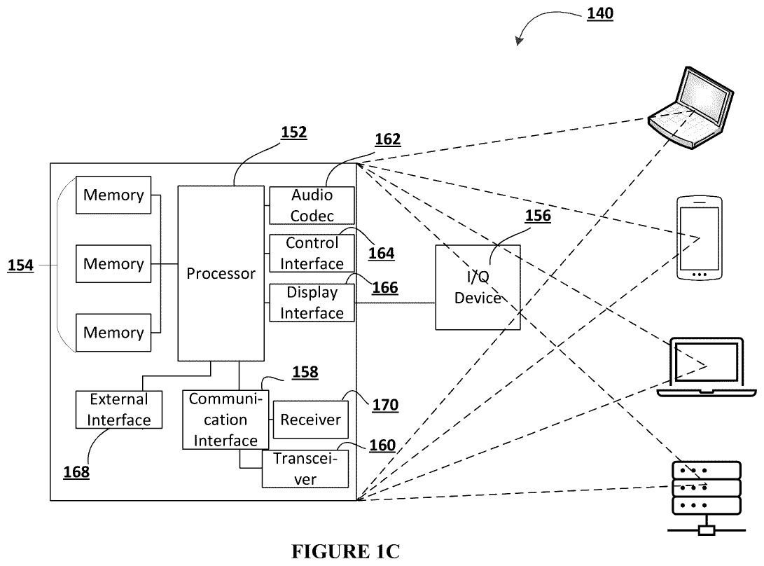

FIGS. 1A-1C illustrate technical components of an exemplary distributed computing environment for identifying network component failures by automatically identifying and filtering anomalous log entries 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the inventions described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the invention. As shown in FIG. 1B, the system 130 may include a processor 102, memory 104, input/output (I/O) device 116, and a storage device 106. The system 130 may also include a high-speed interface 108 connecting to the memory 104, and a low-speed interface 112 (shown as “LS Interface”) connecting to low speed bus 114 (shown as “LS Port”) and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 (shown as “HS Interface”) is coupled to memory 104, input/output (I/O) device 116 (e.g., through a graphics processor or accelerator), and to high-speed expansion ports 111 (shown as “HS Port”), which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the invention. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation—and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert it to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

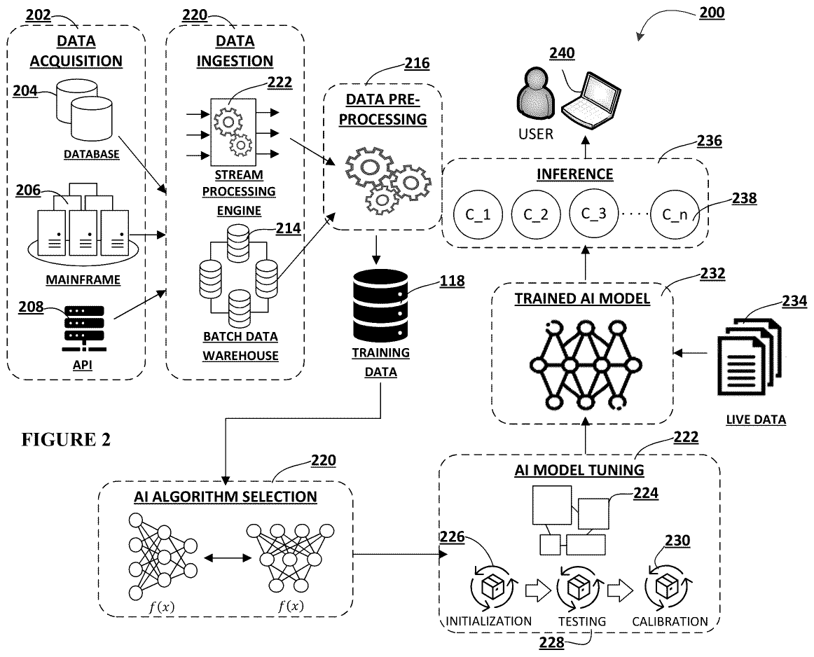

FIG. 2 illustrates an exemplary artificial intelligence (AI) engine subsystem architecture 200, in accordance with an embodiment of the disclosure. The artificial intelligence subsystem 200 may include a data acquisition engine 202, data ingestion engine 210, data pre-processing engine 216, AI engine tuning engine 222, and inference engine 236.

The data acquisition engine 202 may identify various internal and/or external data sources to generate, test, and/or integrate new features for training the artificial intelligence engine 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In artificial intelligence, the quality of data and the useful information that can be derived therefrom directly affects the ability of the artificial intelligence engine 224 to learn. The data pre-processing engine 216 may implement advanced integration and processing steps needed to prepare the data for artificial intelligence execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of artificial intelligence algorithm being used, this training data 218 may require further enrichment. For example, in supervised learning, the training data is enriched using one or more meaningful and informative labels to provide context so an artificial intelligence engine can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The AI tuning engine 222 may be used to train an artificial intelligence engine 224 using the training data 218 to make predictions or decisions without explicitly being programmed to do so. The artificial intelligence engine 224 represents what was learned by the selected artificial intelligence algorithm 220 and represents the rules, numbers, and any other algorithm-specific data structures required for classification. Selecting the right artificial intelligence algorithm may depend on a number of different factors, such as the problem statement and the kind of output needed, type and size of the data, the available computational time, number of features and observations in the data, and/or the like. Artificial intelligence algorithms may refer to programs (math and logic) that are configured to self-adjust and perform better as they are exposed to more data. To this extent, artificial intelligence algorithms are capable of adjusting their own parameters, given feedback on previous performance in making prediction about a dataset.

The artificial intelligence algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable artificial intelligence engine type. Each of these types of artificial intelligence algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

To tune the artificial intelligence engine, the AI tuning engine 222 may repeatedly execute cycles of experimentation 226, testing 228, and tuning 230 to optimize the performance of the artificial intelligence algorithm 220 and refine the results in preparation for deployment of those results for consumption or decision making. To this end, the AI tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the engine is the measurement used to determine which set of hyperparameters is best at identifying relationships and patterns between variables in a dataset based on the input, or training data 218. A fully trained artificial intelligence engine 232 is one whose hyperparameters are tuned and engine accuracy maximized.

The trained artificial intelligence engine 232, similar to any other software application output, can be persisted to storage, file, memory, or application, or looped back into the processing component to be reprocessed. More often, the trained artificial intelligence engine 232 is deployed into an existing production environment to make practical business decisions based on live data 234. To this end, the artificial intelligence subsystem 200 uses the inference engine 236 to make such decisions. The type of decision-making may depend upon the type of artificial intelligence algorithm used. For example, artificial intelligence engines trained using supervised learning algorithms may be used to structure computations in terms of categorized outputs (e.g., C_1, C_2 . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, artificial intelligence engines trained using unsupervised learning algorithms may be used to group (e.g., C_1, C_2 . . . C_n 238) live data 234 based on how similar they are to one another to solve exploratory challenges where little is known about the data, provide a description or label (e.g., C_1, C_2 . . . C_n 238) to live data 234, such as in classification, and/or the like. These categorized outputs, groups (clusters), or labels are then presented to the user input system 130. In still other cases, artificial intelligence engines that perform regression techniques may use live data 234 to predict or forecast continuous outcomes.

It will be understood that the embodiment of the artificial intelligence subsystem 200 illustrated in FIG. 2 is exemplary and that other embodiments may vary. As another example, in some embodiments, the artificial intelligence subsystem 200 may include more, fewer, or different components.

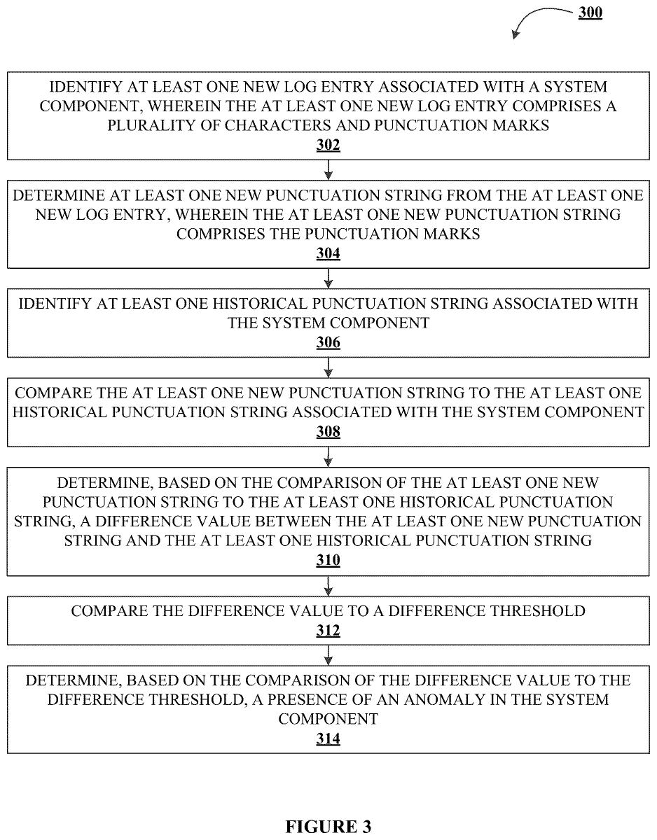

FIG. 3 illustrates a process flow 300 for identifying network component failures by automatically identifying and filtering anomalous log entries, in accordance with an embodiment of the disclosure. In some embodiments, a system (e.g., similar to one or more of the systems described herein with respect to FIGS. 1A-1C) may perform one or more of the steps of process flow 300. For example, a system (e.g., the system 130 described herein with respect to FIG. 1A-1C) may perform the steps of process 300. In some embodiments, an artificial intelligence engine (e.g., such as the AI engine shown in FIG. 2) may perform some or all of the steps described in process flow 300.

As shown in block 302, the process flow 300 may include the step of identifying at least one new log entry associated with a system component, wherein the at least one new log entry comprises a plurality of characters and punctuation marks. For example, the system may collect and/or receive at least one new log entry from at least one system component and/or from a directory/database configured to store a plurality of log files collected over different periods of time. For example, such a directory or database may collect—over a pre-defined period (such as every five minutes, every minute, every ten minutes, every fifteen minutes, every thirty minutes, and/or the like)—all the new log entries from one or more system components associated with a network. In some such embodiments, the system described herein may receive and/or collect these new log entries from the directory or database at the end of each pre-defined period, and upon collecting the new log entries, may perform some or all of the steps described herein. Additionally, and as used herein, such system components that each log entry may be received from may comprise a server, a power supply, cooling system, input devices, a storage component, a data center, a computing device, and other such hardware or software components.

As used herein, each log entry (new and/or historical) may comprise a string of characters and punctuation marks indicating the information of its log event. Such a log event may refer to an instance or occurrence within a network comprising the one or more system components. In some such embodiments, such a log entry may comprise the string indicating the time of the event, the date of the event, and any other such pertinent information identifying the place of the event and the type of event. By way of non-limiting example, a log entry may comprise “2025-12-17 11:45:54.912/UTC INFO [network-thread|AAH0-65432-ABCD-CREDIT] [network.dao.imp1.networkproducerasync record metadata—topic: AAH0-60115-networkA.componentB]” which comprises both characters (e.g., letters, numbers, and/or the like) and punctuation marks.

As shown in block 304, the process flow 300 may include the step of determining at least one new punctuation string from the at least one new log entry, wherein the at least one new punctuation string comprises the punctuation marks. For example, the system may parse and extract the punctuation marks of the new log entry and determine, based on this extraction, punctuation string associated with the new log entry. Thus, and based on the example log entry provided above, a punctuation string comprising “--::./[-|---][...-:--.]” may be determined/generated by the system, and each punctuation mark may be in the same relative sequence as the original log entry. In other words, the at least one new punctuation string may comprise the punctuation marks in a same sequence as the at least one new log entry without the plurality of characters.

In some embodiments, the system may compare the new punctuation string to one or more historical punctuation strings associated with the same system component. Thus, and similar to the new punctuation string and its generation, the at least one historical punctuation string may comprise punctuation marks in a same sequence as an at least one historical log entry without an associated plurality of historical characters.

As shown in block 306, the process flow 300 may include the step of identifying at least one historical punctuation string to the at least one historical punctuation string associated with the system component. For example, the system may identify at least one historical punctuation string based on identifying at least one historical log entry associated with the same or similar system component. In some such embodiments, the similar system component may comprise a system component of the same type, same purpose, same manufacturer, same operating system, and/or the like. Additionally, and/or alternatively, the system may collect the historical punctuation string(s) itself from a database or directly configured to store the one or more historical punctuation strings for each system component analyzed by the system. In some such embodiments, the system may collect or receive only the historical punctuation string(s) for comparison and analysis against the new punctuation string, rather than collecting or receiving the historical log entry(ies) and generating the historical punctuation string(s) every time a comparison of the new punctuation string and the historical punctuation string(s) must occur.

As shown in block 308, the process flow 300 may include the step of comparing the at least one new punctuation string to the at least one historical punctuation string associated with the system component. As used herein, the term “compare,” “comparing,” or “comparison” refers to a determination of the differences and similarities between two or more values, objects, and/or the like. For instance, the system may compare the new punctuation string to the one or more historical punctuation string(s) for the same or similar system component. Such a comparison may comprise a one-to-one comparison of each punctuation mark at each position within the new punctuation string and the historical punctuation string(s). In some such embodiment, and where the new punctuation string or the historical punctuation string(s) comprise more punctuation marks, the additional punctuation marks may indicate a greater difference between the new punctuation string and the historical punctuation string(s).

In some embodiments, an averaged historical punctuation string from a plurality of punctuation strings may be used as a normalized historical punctuation string for a singular comparison against the new punctuation string. In some embodiments, the normalized historical punctuation string may comprise the historical punctuation string for the system component (or similar system component) that occurred the most during the historical pre-defined period. Thus, and in some such embodiments, the normalized historical punctuation string may be compared one-to-one against the new punctuation string to determine a difference value between the averaged or most historical punctuation strings and the new punctuation string. Such a difference value is described in further detail below.

As shown in block 310, the process flow 300 may include the step of determining, based on the comparison of the at least one new punctuation string to the at least one historical punctuation string, a difference value between the at least one new punctuation string and the at least one historical punctuation string. For example, such a difference value may refer to an indication (such as by a percentage, value, integer/number, or weight) of the difference(s) between the at least one new punctuation string and the historical punctuation string(s) (e.g., the normalized historical punctuation string, and/or the historical punctuation string(s)). In this manner, the greater the difference value, the greater the differences between the new punctuation string and the historical punctuation string(s).

In some embodiments, the difference value may indicate a percentage or weight of difference between the at least one new punctuation string and the at least one historical punctuation string. Thus, and in some such embodiments, the greater the percentage or weight, the greater the number of differences between the new punctuation string and the historical punctuation string(s).

As shown in block 312, the process flow 300 may include the step of comparing the difference value to a difference threshold. For example, and similar to the comparison described hereinabove with respect to the historical punctuation string and the new punctuation string, the system may further compare the difference value to a difference threshold. In some such embodiments, the difference threshold may be pre-determined by a user (e.g., a manager, operator, and/or the like) of the system, a user (e.g., manager, owner, operator, and/or the like) of the system component, an AI engine (based on historical log entries that comprised anomalous events, system interruptions, and/or the like), and/or the like. Thus, and in some such embodiments, the difference threshold may likewise comprise a percentage, value, integer/number, or weight, similar to the difference value being compared. In some embodiments, the system may compare the difference value to the difference threshold to determine whether the difference value meets or exceeds the difference threshold.

As shown in block 314, the process flow 300 may include the step of determining, based on the comparison of the difference value to the difference threshold, a presence of an anomaly in the system component. For example, and in some such embodiments where a comparison between the difference value and the difference threshold occurs, a determination of whether one value is less than, equal to, or greater than the other value may occur (e.g., a determination of whether the difference value is less than, equal to, or greater than the difference threshold may occur). For instance, the system may determine an anomaly in the system component is present in an instance where the difference value meets or exceeds difference threshold. In contrast, the system may determine an anomaly in the system component is not present in an instance where the difference value does not meet or exceed than the difference threshold. Thus, and based on such a comparison, the system may automatically and efficiently determine when an interruption event, or an anomaly has occurred within one or more system components that are being processed by the system and new punctuation strings are being generated and compared to historical punctuation strings. Thus, and where major differences (e.g., high difference values) are determined by the system, the system may automatically flag the anomalies and the system component identifier for further analysis and reporting to a user associated with the system component.

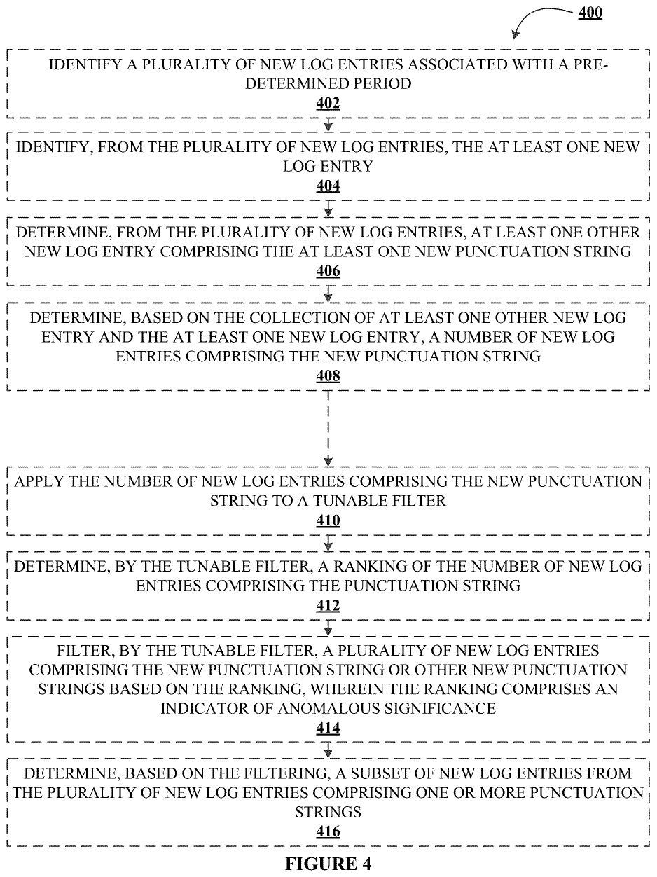

FIG. 4 illustrates a process flow 400 for determining a subset of new log entries based on combining the new log entries with the same punctuation strings and filtering the highest ranked new log entries, in accordance with an embodiment of the disclosure. In some embodiments, a system (e.g., similar to one or more of the systems described herein with respect to FIGS. 1A-1C) may perform one or more of the steps of process flow 400. For example, a system (e.g., the system 130 described herein with respect to FIG. 1A-1C) may perform the steps of process 400. In some embodiments, an artificial intelligence engine (e.g., such as the AI engine shown in FIG. 2) may perform some or all of the steps described in process flow 400.

In some embodiments, and as shown in block 402, the process flow 400 may include the step of identifying a plurality of new log entries associated with a pre-determined period. For example, and in some such embodiments, the system may identify a plurality of new log entries from the pre-determined period. For instance, the system may identify all the new log entries created during the duration of the pre-determined period (e.g., the last five minutes, the last minute, the last ten minutes, the last fifteen minutes, the last thirty minutes, and/or the like).

Further, and in some embodiments, the system may additionally collect historical log entries and/or historical punctuation strings for the same or similar system component for the same or similar historical pre-determined period. Thus, and by way of non-limiting example, if the pre-determined period occurs at 12:00:00 AM on a Monday morning, then a historical pre-determined period may occur at 12:00:00 AM on a previous Monday. In some embodiments, the historical pre-determined period may comprise a similar time (such as 12:00:00 AM on a previous Tuesday, 11:55:00 PM on a previous Sunday, and/or the like).

In some embodiments, and as shown in block 404, the process flow 400 may include the step of identifying, from the plurality of new log entries, the at least one new log entry. For example, the system may identify at least one new log entry and the processes described herein may be performed on the at least one new log entry. However, and in some embodiments, the system may identify a plurality of log entries collected or received from the same pre-determined period. Each of these log entries may then be processed by the steps and process described herein in parallel or in near real time by the system, such that the new punctuation string for each new log entry is identified in near real time by the system. Thus, and as described in further detail herein, the system may determine all the new punctuation strings from each of the new log entries, and then determine which new punctuation strings match for all the new log entries.

In some embodiments, and as shown in block 406, the process flow 400 may include the step of determining, from the plurality of new log entries, at least one other new log entry comprising the at least one new punctuation string. Thus, and based on identifying all the new punctuation strings for the new log entries, the system may determine which new log entries comprise the same punctuation strings, and thus, which new log entries may be categorized together. In some such embodiments, the system may cluster or collect all the new log entries comprising the same new punctuation string and based on clustering the new log entries, the system may determine the number of times the new log entries with the same punctuation string occurred during the pre-determined period.

In some embodiments, and as shown in block 408, the process flow 400 may include the step of determining, based on the collection of at least one other new log entry and the at least one new log entry, a number of log entries comprising the new punctuation string. For example, the system may collect each of the log entries into the same category based on each of the log entries sharing the same punctuation string, and based on this collection, the system may determine the number of log entries comprising the same punctuation string. Thus, and in some embodiments, where many new punctuation strings are identified by the system among the new log entries, the system may determine a plurality of categories each comprising a plurality of log entries each with their own shared punctuation strings.

In some embodiments, and as shown in block 410, the process flow 400 may include the step of applying the number of new log entries comprising the new punctuation string to a tunable filter. For example, and in some embodiments, the tunable filter may change based on the settings input to the tunable filter. For example, such a tunable filter may automatically change based on user inputs received (e.g., user inputs setting a threshold value for the tunable filter), such that the threshold value may change depending on the need for the system to identify more extreme anomalies (e.g., those new log entries that occur a greater number of times than normal). Thus, and in some such embodiments, the tunable filter may determine which numbers should be flagged for each of the numbers of new log entries. For example, the tunable filter may comprise a threshold value which may be compared to each number for each determined number of new log entries, and for each of the cluster of new log entries comprising the number that meets or exceeds the threshold value, then the tunable filter may allow these new log entries to pass through for further analysis and flagged as a potential anomaly.

In some embodiments, the tunable filter may be dynamic and may change based on the number of historical log entries that are associated with the same or similar system component. In this manner, and by way of non-limiting example, if the historical log entries for a historical pre-determined period only includes 4 events, and where the new log entries include a count of 10 events, then the tunable filter may flag the number of log entries as an anomaly. In contrast, and where historical log entries for another system component comprises 9 events as a regular occurrence, and the number of new log entries comprises a count of 10 events, the system may not flag the number of log entries as an anomaly. Thus, and by way of example, the tunable filter may dynamically change based on past numbers of historical log entries for each system component and extreme differences between the historical numbers and the new number for the new log entries.

In some embodiments, and as shown in block 412, the process flow 400 may include the step of determining, by the tunable filter, a ranking of the number of new log entries comprising the punctuation string. For example, the ranking by the tunable filter may comprise an identification of extremely anomalous log entries, slightly anomalous log entries, and not anomalous log entries. Thus, and in some such embodiments, the ranking by the tunable filter may flag each of the log entries based on this ranking. Further, and in some embodiments, the ranking by the tunable filter may filer out only the highest numbers or highest/most extreme different number of new log entries as compared to the number of historical log entries.

In some embodiments, the ranking may comprise a hierarchical ranking from most extreme anomalies to least extreme anomalies. In such an embodiment, the most extreme anomalies may be ranked highest (e.g. those anomalies with the highest difference between the historical number of log entries compared to the number of new log entries).

In some embodiments, and as shown in block 414, the process flow 400 may include the step of filtering, by the tunable filter, a plurality of new log entries comprising the other new punctuation strings based on the ranking, wherein the ranking comprises an indicator of anomalous significance. For example, the filtering may be applied to only allow a top percentage of the ranked number of new log entries. Thus, and based on the ranking, the system may determine an indicator of anomalous significance, such as an indicator showing that one category of new log entries may be extremely anomalous, slightly anomalous, or not anomalous. Thus, and in some embodiments, the filtering of the plurality of new log entries may comprise filtering out the slightly anomalous and not anomalous log entries.

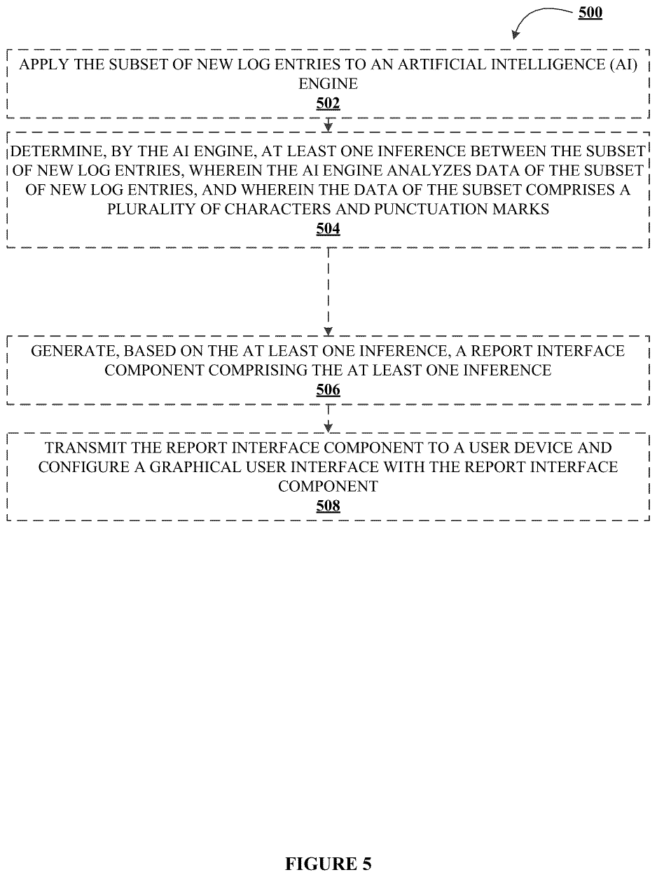

In some embodiments, and as shown in block 416, the process flow 400 may include the step of determining, based on the filtering, a subset of new log entries from the plurality of new log entries comprising one or more punctuation strings. Thus, and in some such embodiments, the system may determine the subset of new log entries as those comprising the extremely anomalous new log entries. Thus, and based on this filtering, the system may accurately, efficiently, and dynamically determine the most extreme anomalous log entries for further analysis and processing. Such extreme anomalous new log entries may thus be used to generate a report interface component like that described below with respect to FIG. 5.

FIG. 5 illustrates a process flow 500 for transmitting a report interface component comprising inference information to a user device for GUI configuration, in accordance with an embodiment of the disclosure. In some embodiments, a system (e.g., similar to one or more of the systems described herein with respect to FIGS. 1A-1C) may perform one or more of the steps of process flow 500. For example, a system (e.g., the system 130 described herein with respect to FIG. 1A-1C) may perform the steps of process 500. In some embodiments, an artificial intelligence engine (e.g., such as the AI engine shown in FIG. 2) may perform some or all of the steps described in process flow 500.

In some embodiments, and as shown in block 502, the process flow 500 may include the step of applying the subset of new log entries to an artificial intelligence (AI) engine. For example, the system may apply the subset of new log entries that was determined in FIG. 4 to a pre-trained AI engine. Such a pre-trained AI engine may have been pre-trained on historical log entries, relationships between the historical log entries, and inferences drawn from these relationships. In some embodiments, the AI engine may comprise regression AI, correlation AI, clustering AI and/or classification AI, such that the AI engine is configured to and capable of analyzing the filtered subset of new log entries and other related data (e.g., the underlying data and any other related data of the events for each log entry) to determine patterns, relationships, and inferences between the events associated with the subset of new log entries.

In some embodiments, and as shown in block 504, the process flow 500 may include the step of determining, by the AI engine, at least one inference between the subset of new log entries, wherein the AI engine analyzes data of the subset of new log entries, and where the data of the subset comprises a plurality of characters and punctuation marks. For example, the system may determine at least one inference between the subset of new log entries, and such an inference may comprise but is not limited to drawing inferences and relationships between system components that may have connected events, geographic locations of the events, daily/week/monthly patterns for the system components, relationships to over events, abnormal occurrences, and/or the like.

In some embodiments, and as shown in block 506, the process flow 500 may include the step of generating, based on the at least one inference, a report interface component comprising the at least one inference. For instance, and based on the at least one inference determined by the AI engine, the system may generate a report interface component comprising the data/information of the at least one inference. In this manner, the report interface component may comprise computer-readable data that may configure a receiving user device's graphical user interface to automatically render the information of the report interface component to a user of the user device.

In some embodiments, and as shown in block 508, the process flow 500 may include the step of transmitting the report interface component to a user device and configuring a graphical user interface (GUI). Thus, and in this manner, the system may transmit the report interface component over a network to a recipient user device (such as a recipient user device associated with a user of the system, a user of the system component, and/or the like) for analyzing which system components are undergoing anomalous behavior and which system components may need to be fixed to avoid or mitigate the interruption or anomaly. Therefore, and in some such embodiments, the system may automatically trigger, based on transmitting the report interface component to the user device, the user device's GUI to show the report interface component.

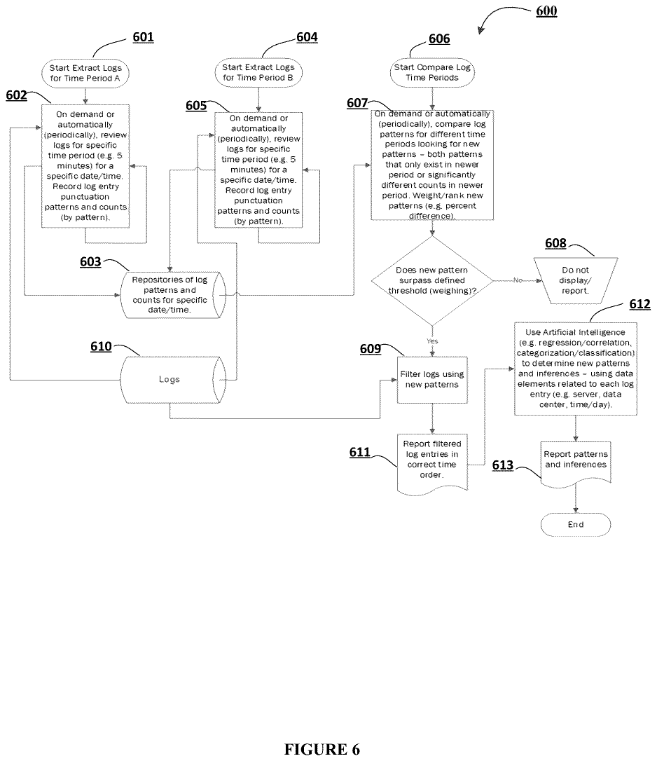

FIG. 6 illustrates a flow diagram 600 for identifying network component failures by automatically identifying and filtering anomalous log entries, in accordance with an embodiment of the disclosure. In some embodiments, a system (e.g., similar to one or more of the systems described herein with respect to FIGS. 1A-1C) may perform one or more of the steps of process flow 600. For example, a system (e.g., the system 130 described herein with respect to FIG. 1A-1C) may perform the steps of process 600. In some embodiments, an artificial intelligence engine (e.g., such as the AI engine shown in FIG. 2) may perform some or all of the steps described in process flow 600.

For instance, and as shown in process flow 600 shows the system may extract logs for a time period A 601 (e.g., a pre-determined period), whereby such logs may comprise new log entries. Further, and as shown in block 602, the system may automatically (either on demand-such as by a user triggering the processes described herein to start, or periodically) review the logs for the specific time period (e.g., pre-determined period) for a specific date and time. Upon reviewing the log entries, the system may record log entry punctuation patterns and counts (e.g., new punctuation strings).

Further, and in some embodiments, the system may have previously or currently extracted logs for a time period B (e.g., historical pre-determined period) 604. Based on this extraction, the system may likewise automatically (on demand or periodically) review the log entries for the specific time period for a specific date and time (e.g., historical pre-determined period), and may record log entry punctuation patterns and counts for these historical log entries. In some embodiments, and based on the extraction of the historical log entries and/or the extraction of the new log entries, the system may input both types of log entries into a database, repository, or directory (e.g., a repository of log patterns and counts for specific date/time) 603.

Further, and at block 606, the system may trigger the start of comparing the new log entries (e.g., the new punctuation strings) and the historical log entries (e.g., the historical punctuation strings) for the specific time periods. For instance, and in block 607, the system may (on demand or automatically/periodically) compare log patterns for different time periods to look for new patterns (i.e., compare punctuation strings to look for new punctuation strings)—both patterns that only exist in new period and/or significantly different counts in newer period. Further, and in some embodiments, the system may weight/rank the new patterns (e.g., percent difference).

Based on the process performed in block 607, the system may determine if a new pattern (e.g., new punctuation string) surpasses defined threshold (e.g., is the new punctuation string an extreme anomaly based on the number of new patterns or the type of new pattern)? If the pattern does not surpass, then the system may not display the pattern within the report (e.g., report interface component) 608.

In contrast, and in an instance where the new pattern does surpass the defined threshold, then the system may filer the logs using the new patterns (e.g., from a database/directory 610 comprising all the logs collected from 602 and 605), such that only the extreme anomaly log entries are left. Further, and based on this filtering, the system may report filtered log entries in the correct time order which they occurred 611. Additionally, and in some embodiments, the system may use an AI engine to determine new patterns and inferences (e.g., using data elements related to each log entry, such as server, data center, time/day, and/or the like 612. Lastly, and in some such embodiments, the log entries identified as comprising anomalies may be reported as patterns and inferences to a user associated with the system or the system component 613.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These computer-executable program code portions execute via the processor of the computer and/or other programmable data processing apparatus and create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for identifying network component failures by automatically identifying and filtering anomalous log entries, the system comprising:
a memory device with computer-readable program code stored thereon;
at least one processing device operatively coupled to the memory device and at least one communication device, wherein executing the computer-readable code is configured to cause the at least one processing device to:
identify at least one new log entry associated with a system component, wherein the at least one new log entry comprises a plurality of characters and punctuation marks;
determine at least one new punctuation string from the at least one new log entry, wherein the at least one new punctuation string comprises the punctuation marks;
identify at least one historical punctuation string associated with the system component;
compare the at least one new punctuation string to the at least one historical punctuation string associated with the system component;
determine, based on the comparison of the at least one new punctuation string to the at least one historical punctuation string, a difference value between the at least one new punctuation string and the at least one historical punctuation string;
compare the difference value to a difference threshold; and
determine, based on the comparison of the difference value to the difference threshold, a presence of an anomaly in the system component.

2. The system of claim 1, wherein the difference value indicates a percentage or weight of difference between the at least one new punctuation string and the at least one historical punctuation string.

3. The system of claim 1, wherein the difference threshold is at least one of a pre-determined threshold value by at least one of a user associated with the system component or by an artificial intelligence (AI) engine.

4. The system of claim 1, wherein the anomaly in the system component is present in an instance where the difference value meets or exceeds difference threshold.

5. The system of claim 1, wherein the anomaly in the system component is not present in an instance where the difference value does not meet or exceed than the difference threshold.

6. The system of claim 1, wherein executing the computer-readable code is further configured to cause the at least one processing device to:
identify a plurality of new log entries associated with a pre-determined period;
identify, from the plurality of new log entries, the at least one new log entry;
determine, from the plurality of new log entries, at least one other new log entry comprising the at least one new punctuation string; and
determine, based on the collection of at least one other new log entry and the at least one new log entry, a number of new log entries comprising the new punctuation string.

7. The system of claim 6, wherein executing the computer-readable code is further configured to cause the at least one processing device to:
apply the number of new log entries comprising the new punctuation string to a tunable filter;
determine, by the tunable filter, a ranking of the number of new log entries comprising the new punctuation string;
filter, by the tunable filter, a plurality of new log entries comprising the new punctuation string or other new punctuation strings based on the ranking, wherein the ranking comprises an indicator of anomalous significance; and
determine, based on the filtering, a subset of new log entries from the plurality of new log entries comprising one or more punctuation strings.

8. The system of claim 7, wherein executing the computer-readable code is further configured to cause the at least one processing device to:
apply the subset of new log entries to an artificial intelligence (AI) engine; and
determine, by the AI engine, at least one inference between the subset of new log entries, wherein the AI engine analyzes data of the subset of new log entries, and wherein the data of the subset comprises a plurality of characters and punctuation marks.

9. The system of claim 8, wherein executing the computer-readable code is further configured to cause the at least one processing device to:
generate, based on the at least one inference, a report interface component comprising the at least one inference; and
transmit the report interface component to a user device and configure a graphical user interface with the report interface component.

10. The system of claim 1, wherein the at least one historical punctuation string is based on the system component at a same historical pre-determined period.

11. The system of claim 1, wherein the at least one historical punctuation string is based on the system component at a similar historical pre-determined period.

12. The system of claim 1, wherein the at least one new punctuation string comprises the punctuation marks in a same sequence as the at least one new log entry without the plurality of characters.

13. The system of claim 1, wherein the at least one historical punctuation string comprises punctuation marks in a same sequence as an at least one historical log entry without an associated plurality of historical characters.

14. A computer program product for identifying network component failures by automatically identifying and filtering anomalous log entries, wherein the computer program product comprises at least one non-transitory computer-readable medium having computer-readable program code portions embodied therein, the computer-readable program code portions which when executed by a processing device are configured to cause the processor to:
identify at least one new log entry associated with a system component, wherein the at least one new log entry comprises a plurality of characters and punctuation marks;
determine at least one new punctuation string from the at least one new log entry, wherein the at least one new punctuation string comprises the punctuation marks;
identify at least one historical punctuation string associated with the system component;
compare the at least one new punctuation string to the at least one historical punctuation string associated with the system component;
determine, based on the comparison of the at least one new punctuation string to the at least one historical punctuation string, a difference value between the at least one new punctuation string and the at least one historical punctuation string;
compare the difference value to a difference threshold; and
determine, based on the comparison of the difference value to the difference threshold, a presence of an anomaly in the system component.

15. The computer program product of claim 14, wherein the computer-readable program code portions which when executed by the processing device are configured to cause the processor to:
identify a plurality of new log entries associated with a pre-determined period;
identify, from the plurality of new log entries, the at least one new log entry;
determine, from the plurality of new log entries, at least one other new log entry comprising the at least one new punctuation string; and
determine, based on the collection of at least one other new log entry and the at least one new log entry, a number of new log entries comprising the new punctuation string.

16. The computer program product of claim 14, wherein the computer-readable program code portions which when executed by the processing device are configured to cause the processor to:
apply the number of new log entries comprising the new punctuation string to a tunable filter;
determine, by the tunable filter, a ranking of the number of new log entries comprising the new punctuation string;
filter, by the tunable filter, a plurality of new log entries comprising the new punctuation string or other new punctuation strings based on the ranking, wherein the ranking comprises an indicator of anomalous significance; and
determine, based on the filtering, a subset of new log entries from the plurality of new log entries comprising one or more punctuation strings.

17. The computer program product of claim 14, wherein the computer-readable program code portions which when executed by the processing device are configured to cause the processor to:
apply the subset of new log entries to an artificial intelligence (AI) engine; and
determine, by the AI engine, at least one inference between the subset of new log entries, wherein the AI engine analyzes data of the subset of new log entries, and wherein the data of the subset comprises a plurality of characters and punctuation marks.

18. A computer implemented method for identifying network component failures by automatically identifying and filtering anomalous log entries, the computer implemented method comprising:
identifying at least one new log entry associated with a system component, wherein the at least one new log entry comprises a plurality of characters and punctuation marks;
determining at least one new punctuation string from the at least one new log entry, wherein the at least one new punctuation string comprises the punctuation marks;
identifying at least one historical punctuation string associated with the system component;
comparing the at least one new punctuation string to the at least one historical punctuation string associated with the system component;
determining, based on the comparison of the at least one new punctuation string to the at least one historical punctuation string, a difference value between the at least one new punctuation string and the at least one historical punctuation string;
comparing the difference value to a difference threshold; and
determining, based on the comparison of the difference value to the difference threshold, a presence of an anomaly in the system component.

19. The computer implemented method of claim 18, further comprising:
identifying a plurality of new log entries associated with a pre-determined period;
identifying, from the plurality of new log entries, the at least one new log entry;
determining, from the plurality of new log entries, at least one other new log entry comprising the at least one new punctuation string; and
determining, based on the collection of at least one other new log entry and the at least one new log entry, a number of new log entries comprising the new punctuation string.

20. The computer implemented method of claim 18, further comprising:
applying the number of new log entries comprising the new punctuation string to a tunable filter;
determining, by the tunable filter, a ranking of the number of new log entries comprising the new punctuation string;
filtering, by the tunable filter, a plurality of new log entries comprising the new punctuation string or other new punctuation strings based on the ranking, wherein the ranking comprises an indicator of anomalous significance; and
determining, based on the filtering, a subset of new log entries from the plurality of new log entries comprising one or more punctuation strings.
